(19) United States
(12) Patent Application Publication
(10) Pub. No.: US 2006/0077474 A1
(43) Pub. Date: Apr. 13, 2006

(54) Image forming apparatus, image forming system and method of controlling apparatus

(75) Inventor: Hiroshi Watanabe, Yokohama-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Tokyo (JP); Toshiba Tec Kabushiki Kaisha, Chiyoda-ku (JP)

(21) Appl. No.: 10/961,687

(22) Filed: Oct. 8, 2004

(51) Int. Cl. H04N 1/40

(52) U.S. Cl. 358/448

(57) ABSTRACT

Each time image information is read from a document, the number of times it is read is counted. When the image information is read from the document, a Job ID inherent to the read image information is generated by a combination of an apparatus number inherent to the image forming apparatus and the count value.

### BACKGROUND OF THE INVENTION

1. Field of the Invention

The present invention relates to an image forming apparatus which reads and stores an image, an image forming system which has a plurality of image forming apparatuses, and a method of controlling the image forming apparatus.

2. Description of the Related Art

In general, an image forming apparatus reads image information of a document and prints the read image information on a paper sheet. There is an image forming apparatus having a function for storing read image information in a storing unit, searches and reads out desired image information from image information stored in the storing unit, and prints the read image information to a paper sheet or displays it on a display unit, in addition to the copy function described above. In this image forming apparatus, when a file name is given to the read image information, the image information can be easily searched and read out.

However, the file name is given by a user. Accordingly, there is a possibility that a plurality of pieces of image information having the same file name exists. If a plurality of pieces of image information having the same name exist, it is difficult to read out image information appropriately.

### BRIEF SUMMARY OF THE INVENTION

An object of the present invention, which is made in view of the above circumstances, is to provide an image forming apparatus, an image forming system, and a method of controlling the image forming apparatus which can appropriately read out image information desired by a user.

An image forming apparatus according to the invention comprises:
a scanner configured to read the image information of a document;
a storing unit configured to store the image information read by the scanner;
a counter configured to count the number of times the scanner reads the image information; and
a generation part configured to generate, when the image information is read by the scanner, identification information inherent to the image information read by the scanner by a combination of an apparatus number inherent to the image forming apparatus and a count value of the counter.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a view showing a configuraiton of an embodiment according to the present invention;

FIG. 2 is a view showing the configuratin of a control panel of the embodiment;

FIG. 3 is a block diagram showing a control circuit of the embodiment;

FIG. 4 is a flowchart explaining an operation of the embodiment;

FIG. 5 is a view showing a format of a management table of the embodiment;

FIG. 6 is a view explaining processing executed by the embodiment; and

FIG. 7 is a view explaining another processing executed by the embodiment.

### DETAILED DESCRIPTION OF THE INVENTION

An embodiment of the present invention will be explained with reference to the drawings.

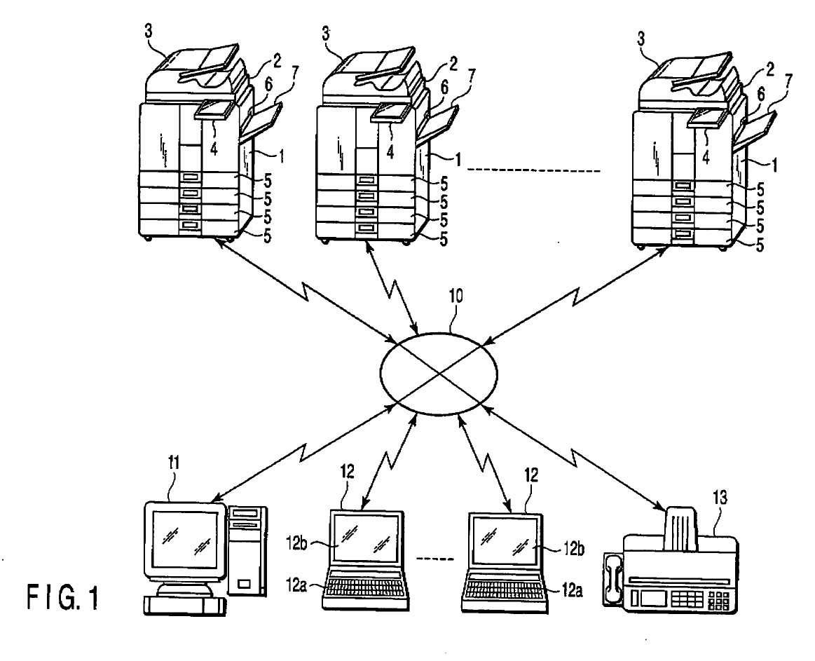

As shown in FIG. 1, there are installed a plurality of 1 to n image forming apparatuses 1. Each of the image forming apparatuses 1 has a document table 2 in an upper portion. An automatic document feeder (ADF) 3 is openably/closably disposed on the document table 2. A control panel 4 is disposed at a position as high as the document table 2 to set operating conditions. A plurality of cassettes 5, in which various sizes of paper sheets are accommodated, are disposed in a lower portion of the image forming apparatus 1. A paper sheet, on which an image is printed by the image forming apparatus 1, is discharged from a sheet discharge port 6 on a side of the image forming apparatus 1 onto a tray 7.

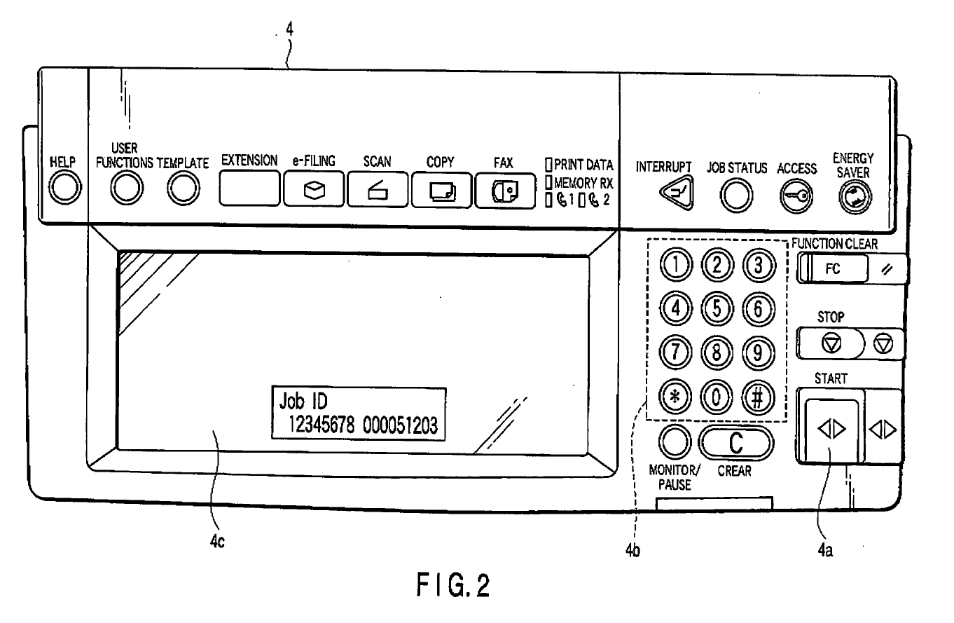

As shown in FIG. 2, the control panel 4 has a start key 4a, ten keys 4b, and the like which constitute an operating part through which information is input as well as a liquid crystal display screen 4c as a display part.

A server 11, a plurality of 1 to n terminals 12 (for example, personal computers), a facsimile device 13, and the like are connected to the image forming apparatuses 1 through a communication network 10. An image forming system is composed of the image forming apparatuses 1, the communication network 10, the server 11, the terminals 12, the facsimile device 13, and the like. Each of the terminals 12 has a keyboard 12a, which is the operating part through which information is input as well as a liquid crystal display screen 12b as a display part.

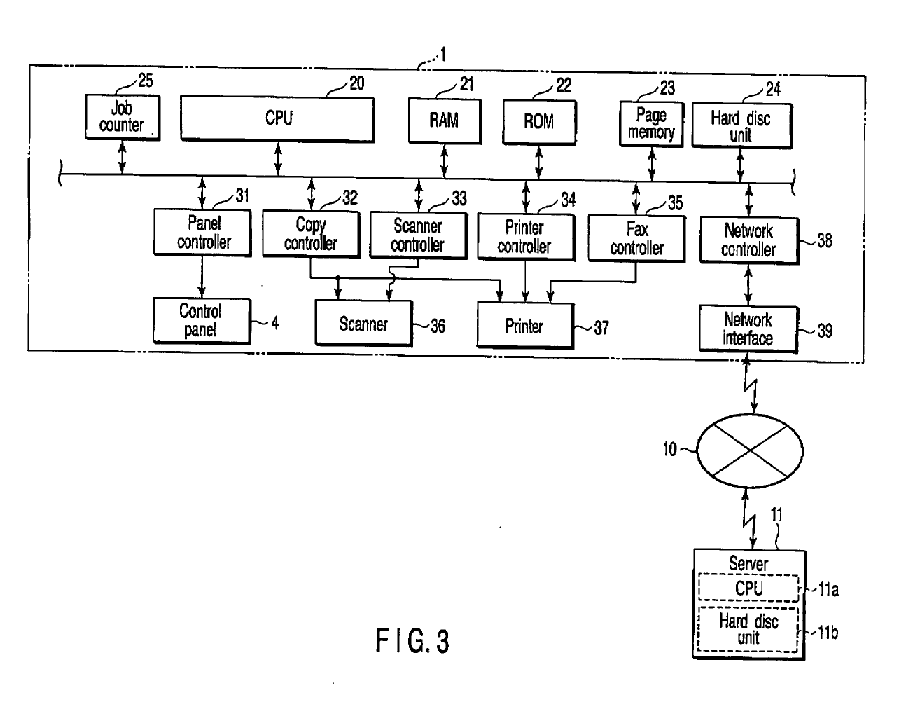

FIG. 3 shows a control circuit of each or the image forming apparatuses 1.

The image forming apparatus 1 has a CPU 20, and a RAM 21, a ROM 22, a page memory 23, a large capacity storing unit, for example, a hard disc unit 24, a job counter 25, a panel controller 31, a copy controller 32, a scanner controller 33, a printer controller 34, a facsimile (Fax) controller 35, and a network controller 38 connected to the CPU 20.

The RAM 21 is used to store various kinds of data. The ROM 22 stores various kinds of control programs necessary to operate the image forming apparatus 1, as well as an apparatus number N inherent to the image forming apparatus 1. The page memory 23 temporarily stores the image information of a document read by a scanner 36. The hard disc unit 24 stores the image information output from the page memory 23. The job counter 25 counts the number of times T the scanner 36 reads image information.

The panel controller 31 controls the control panel 4. The copy controller 32 controls an ordinary copy function using the scanner 36 and a printer 37. The scanner controller 33 controls a scanner function of a network scanning and the like using the scanner 36. The printer controller 34 controls a printer function of a network printing and the like using the printer 37. The facsimile controller 35 controls a facsimile function using the printer 37. The scanner 36 optically reads the image information of a document set on the document table 2 or on the automatic document feeder 3. The printer 37 prints the image information output from the page memory 23 and the image information read out from the hard disc unit 24 to a paper sheet supplied from one of the cassettes 5.

The network controller 38 controls data transmission/reception executed between the image forming apparatus 1 and external equipment through a network interface 39. The network interface 39 includes a LAN board, a facsimile modem, and the like and is connected to the server 11 as the external equipment, the terminals 12, and the like through the communication network 10. The server 11 has a CPU 11a as well as a hard disc unit 11b as a large capacity management storing unit.

The CPU 20 of each image forming apparatus 1 has the following parts (1) to (5) as the main functions thereof:

(1) a generation part which generates, when image information is read by the scanner 36, identification information, that is, a so-called Job ID inherent to the image information read by the scanner 36 by a combination of an apparatus number inherent to the image forming apparatus 1 and the count value T of the job counter 25

(2) a control part which displays the Job ID generated by the above generation part on the liquid crystal display screen 4c of the control panel 4.

(3) a control part which generates management information composed of at least the Job ID generated by the generation part and the stored address of the image information stored in the hard disc unit 24 and sends the management information to the server 11.

(4) a control part which prints the image information read by the scanner 36 and the Job ID generated by the generation part to a single paper sheet by the printer 37.

(5) a control part which reads out, when a Job ID is input on the control panel 4, the image information corresponding to the input Job ID from the hard disc units 24 of the image forming apparatuses 1 referring to the management information stored in the hard disc unit 11b of the server 11 and prints the image information by the printer 37 of the image forming apparatus 1.

The CPU 11a of the server 11 has the following parts (11) to (13) as the main functions thereof:

(11) a control part which stores the management information sent from the image forming apparatuses 1 in the hard disc unit 11b.

(12) a control part, which reads out, when a Job ID is input from any of the terminals 12, management information in which the input Job ID is included from the hard disc unit 11b and displays it on any of the liquid crystal display screens 12b of the terminals 12.

(13) a control part which reads out, when a Job ID is input through any of the terminals 12, the image information corresponding to the input Job ID from the hard disc units 24 of the image forming apparatuses 1 referring to the stored address of the management information stored in the hard disc unit 11b and prints the image information by any of the printers 37 of the image forming apparatuses 1.

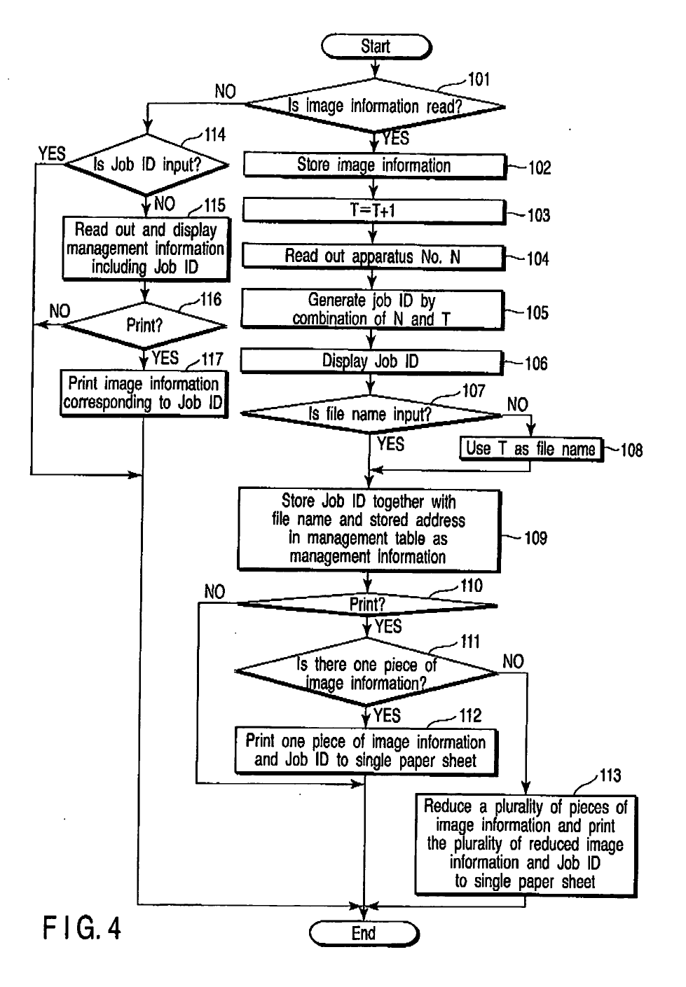

Next, an operation of the image forming system will be explained with reference to the flowchart of FIG. 4.

When image information is read by the scanner 36 of, for example, a first image forming apparatus 1 of the image forming apparatuses 1 (YES at step 101), the read image information is stored in the hard disc unit 24 of the first image forming apparatus 1 through the page memory 23 of the first image forming apparatus 1 (step 102). At the time, the count value T of the job counter 25 of the first image forming apparatus 1 is incremented by “1” (step 103). Then, an apparatus number N, for example, “123456” is read out from the ROM 22 of the first image forming apparatus 1 (step 104), and a combination “1234560000512031” of the apparatus number N and the count value T of the job counter 25, for example, “000051203” is generated as identification information inherent to the image information read by the scanner 36, that is, as a so-called Job ID (step 105). The generated Job ID is displayed on the liquid crystal display screen 4c of the control panel 4 as shown in FIG. 2 (step 106). The Job ID of the read image information is notified to a user by displaying it.

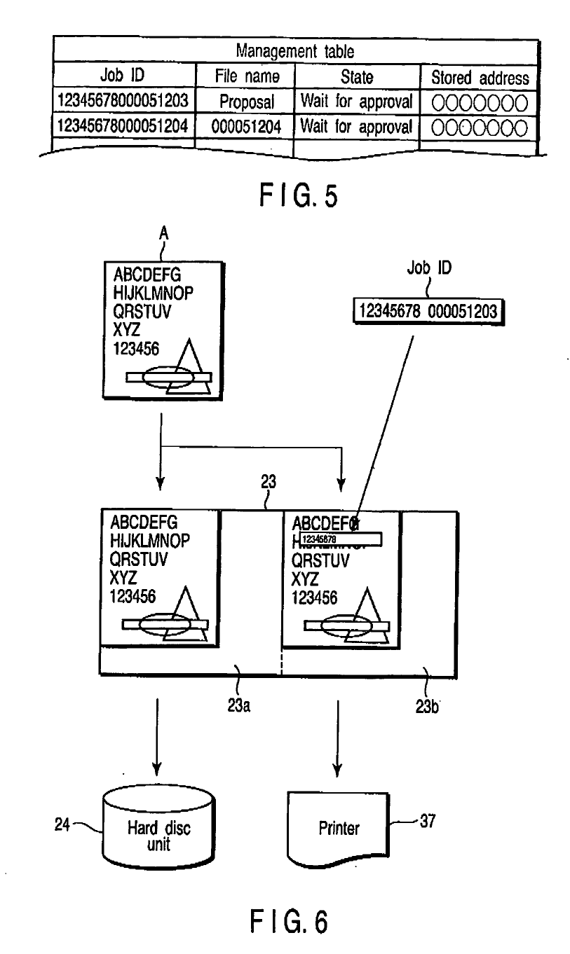

When a file name is input on the control panel 4 by the user (YES at step 107), management information is generated by the input file name, the Job ID, the stored address of the image information stored in the hard disc unit 24. The generated management information is sent to the server 11 and stored in a management table in the hard disc unit 11b (step 108). FIG. 5 shows a format of the management table. The management information stored in the management table includes an item showing a state of the stored image information (for example, the image information a waits approval, has been approved, and the like), in addition to the Job ID, the file name, the stored address. When no file name is input (NO at step 107), the count value T of the job counter 25 is used as the file name (step 109).

When “print” is indicated on the control panel 4 by the user (YES at step 110), it is determined whether or not the read image information is one piece (whether or not the image information of one document is read) (step 111).

When the read image information is one piece (YES at step 111), the one piece of the image information and the generated Job ID are printed to a paper sheet by the printer 37 (step 112). FIG. 6 shows how the processing is executed. That is, one piece of image information read from a document A is stored in the hard disc unit 24 through a first region 23a of the page memory 23. The read one piece of the image information is stored in a second region 23b of the page memory 23, and the Job ID is stored by being overlapped on the image information. The image information and the Job ID in the second region 23b are printed by the printer 37.

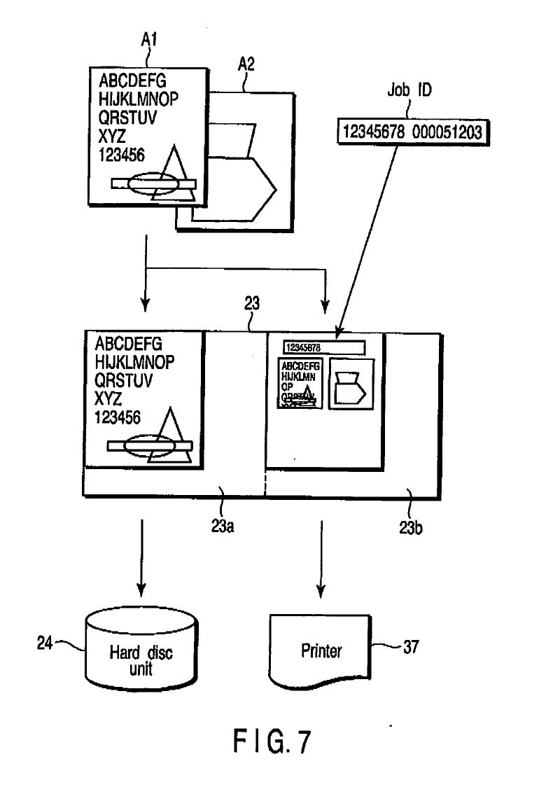

When a plurality of pieces of image information (information of a plurality of documents) are read (NO at step 111), the plurality of pieces of the image information are reduced, and the plurality of pieces of the image information and the Job ID generated as described above are printed to a single paper sheet by the printer 37 (step 113). FIG. 7 shows how the processing is executed. That is, two pieces of image information read from documents A1 and A2 are sequentially stored in the hard disc unit 24 through the first region 23a of the page memory 23. The two pieces of the read image information are stored in the second region 23b of the page memory 23, respectively after they are reduced, and a Job ID is stored. The image information and the Job ID in the second region 23b are printed by the printer 37.

The user can easily grasp a corresponding relation between the one piece or the plurality of pieces of image information input to the image forming apparatus 1 and the Job ID set to the image information by observing the printed single paper sheet.

In contrast, when a Job ID is input on the control panel 4 of the first image forming apparatus (YES at step 114), the image information corresponding to the input Job ID is read out from any of the hard disc units 24 of the image forming apparatuses 1 referring to the stored address of the management information stored in the hard disc unit 11b of the server 11 and sent to the first image forming apparatus 1. The image information sent to the first image forming apparatus 1 is displayed by the control panel 4 of the first image forming apparatus 1 (step 115). At the time, when the user indicates “print” on the control panel 4 (YES at step 116), the image information sent to the first image forming apparatus 1 is printed to a paper sheet by the printer 37 of the first image forming apparatus 1 (step 117).

Likewise, when a Job ID is input on the control panel 4 of the n-th image forming apparatus (YES at step 114), the image information corresponding to the input Job ID is read out from any of the hard disc units 24 of the image forming apparatuses 1 referring to the stored address of the management information stored in the hard disc unit 11b of the server 11 and sent to the n-th image forming apparatus 1. The image information sent to the n-th image forming apparatus 1 is displayed by the control panel 4 of the n-th image forming apparatus 1 (step 115). At the time, when the user indicates “print” on the control panel 4 (YES at step 116), the image information sent to the n-th image forming apparatus 1 is printed to a paper sheet by the printer 37 of the n-th image forming apparatus 1 (step 117).

When a Job ID is input through the first terminal 12 (YES at step 114), management information including the input Job ID is read out from the hard disc unit 11b of the server 11. The read management information is sent to the first terminal 12 and displayed on the liquid crystal display screen 4c of the first terminal 12 (step 115). The user can easily grasp a state of the image information corresponding to the input Job ID (for example, the image information a waits approval, has been approved, and the like) by observing the displayed management information.

At the time, when “print” is indicated through the first terminal 12 (YES at step 116), the image information corresponding to the input Job ID is read out from any of the hard disc units 24 of the image forming apparatuses 1 based on the stored address of the displayed management information. The read image information is printed to a paper sheet by any of the printers 37 of the image forming apparatuses 1 (step 117). In this case, the user can designate an image forming apparatus 1, by which the image information is printed, from the image forming apparatuses 1 by operating the first terminal 12.

Likewise, when a Job ID is input through the n-th terminal 12 (YES at step 114), management information including the input Job ID is read out from the hard disc unit 11b of the server 11. The read management information is sent to the n-th terminal 12 and displayed on the liquid crystal display screen 4c of the n-th terminal 12 (step 115). The user can easily grasp a state of the image information corresponding to the input Job ID (for example, the image information a waits approval, has been approved, and the like) by observing the displayed management information.

At the time, when “print” is indicated through the n-th terminal 12 (YES at step 116), the image information corresponding to the input Job ID is read out from any of the hard disc units 24 of the image forming apparatuses 1 based on the stored address of the displayed management information. The read image information is printed to a paper sheet by any of the printers 37 of the image forming apparatuses 1 (step 117). In this case, the user can designate an image forming apparatus 1, by which the image information is printed, from the image forming apparatuses 1 by operating the first terminals 12.

As described above, it is possible to appropriately read out and print the image information desired by the user by generating a Job ID inherent to read image information.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. An image forming apparatus, comprising:
a scanner configured to read the image information of a document;
a storing unit configured to store the image information read by the scanner;
a counter configured to count the number of times the scanner reads the image information; and
a generation part configured to generate, when the image information is read by the scanner, identification information inherent to the image information read by the scanner by a combination of an apparatus number inherent to the image forming apparatus and a count value of the counter.

2. An image forming apparatus according to claim 1, further comprising:
a printer to print the image information read by the scanner to a paper sheet;
an operating part through which information is input; and
a control part configured to read out, when the identification information is input through the operating part, the image information corresponding to the input identification information from the storing unit and to print the image information by the printer.

3. An image forming apparatus according to claim 2, further comprising:
a display part; and
a control part configured to display the identification information generated by the generation part on the display part.

4. An image forming apparatus according to claim 2, further comprising a control part configured to print the image information read by the scanner and the identification information generated by the generation part to a single paper sheet by the printer.

5. An image forming apparatus according to claim 4, wherein the control part is configured such that when one piece of image information is read by the scanner, the control part prints the read one piece of the image information and the identification information generated by the generation part to a single paper sheet by the printer, and when a plurality of pieces of image information are read by the scanner, the control part reduces the plurality of pieces of the read image information and prints the plurality of pieces of the reduced image information and the identification information generated by the generation part to a single paper sheet by the printer.

6. An image forming apparatus according to claim 1, further comprising:
a printer that prints the image information read by the scanner to a paper sheet;
an operating part through which information is input;
a management storing unit configured to store management information composed of at least the identification information generated by the generation part and the address of the image information stored in the storing unit; and
a first control part configured to read out, when the identification information is input through the operating part, the image information corresponding to the input identification information from the storing unit referring to the management information stored in the management storing unit and to print the image information by the printer.

7. An image forming apparatus according to claim 6, further comprising:
a display part; and
a second control part configured to display the identification information generated by the generation part on the display part.

8. An image forming apparatus according to claim 6, further comprising a second control part configured to print the image information read by the scanner and the identification information generated by the generation part to a single paper sheet by the printer.

9. An image forming apparatus according to claim 8, wherein the second control part is configured such that when one piece of image information is read by the scanner, the second control part prints the read one piece of the image information and the identification information generated by the generation part to a single paper sheet by the printer, and when a plurality of pieces of image information are read by the scanner, the second control part reduces the plurality of pieces of read image information and prints the plurality of pieces of the reduced image information and the identification information generated by the generation part to a single paper sheet by the printer.

10. An image forming apparatus according to claim 6, wherein the management information comprises the identification information generated by the generation part, information showing a state of the image information stored in the storing unit, and the stored address of the image information stored in the storing unit.

11. An image forming apparatus according to claim 6, wherein the management storing unit is disposed to a server connected to the apparatus through a network.

12. An image forming system, comprising:
a plurality of image forming apparatuses;
at least one terminal connected to the image forming apparatuses through a network; and
a server connected to the image forming apparatuses through the network,
wherein each or the image forming apparatuses comprises:
a scanner configured to read the image information of a document;
a storing unit configured to store the image information read by the scanner;
a counter configured to count the number of times the scanner reads the image information; and
a generation part configured to generate, when the image information is read by the scanner, identification information inherent to image information read by the scanner by a combination of an apparatus number inherent to the apparatus and a count value of the counter;
a printer that prints the image information read by the scanner to a paper sheet;
an operating part through which information is input; and
a display part,
wherein the terminal comprises:
an operating part through which information is input; and
a display part, and
wherein the server comprises:
a management storing unit configured to store management information composed of at least the identification information generated by the generation part and the stored address of the image information stored in the storing unit; and
a control part configured to read out, when the identification information is input through any of the operating parts, the image information corresponding to the input identification information from the storing units of the image forming apparatuses referring to the management information stored in the management storing unit and prints the image information by any of the printers of the image forming apparatuses.

13. An image forming system according to claim 12, wherein each of the image forming apparatuses further comprises a control part configured to display the identification information generated by the generation part on the display part.

14. An image forming system according to claim 12, wherein each of the image forming apparatuses further comprises a control part configured to print the image information read by the scanner and the identification information generated by the generation part to a single paper sheet by the printer.

15. An image forming system according to claim 14, wherein the control part of each of the image forming apparatuses is configured such that when one piece of image information is read by the scanner, the control part prints the read one piece of the image information and the identification information generated by the generation part to a single paper sheet by the printer, and when a plurality of pieces of image information are read by the scanner, the control part reduces the plurality of pieces of the read image information and prints the plurality of pieces of the reduced image information and the identification information generated by the generation part to a single paper sheet by the printer.

16. An image forming system according to claim 12, wherein the server further comprises a control part that reads out, when the identification information is input through any of the operating parts, management information in which the input identification information is included from the management storing unit and displays the management information by any of the display parts.

17. An image forming system according to claim 12, wherein the management information is composed of the identification information generated by the generation part, information showing a state of the image information stored in the storing unit, and the stored address of the image information stored in the storing unit.

18. A method of controlling an image forming apparatus comprising:
reading image information of a document;
storing the read image information;
counting the number of times the image information is read; and
generating identification information inherent to the read image information, when the image information is read, by a combination of an apparatus number inherent to the image forming apparatus and the count value.
